(19) United States
(12) Patent Application Publication
(10) Pub. No.: US 2016/0365979 A1
(43) Pub. Date: Dec. 15, 2016

(54) Methods and Apparatuses for Pattern Detection in Distorted Communication Data

(71) Applicant: Anthony Mai, San Marcos, CA (US)

(72) Inventor: Anthony Mai, San Marcos, CA (US)

(73) Assignee: Anthony Mai, San Marcos, CA (US)

(21) Appl. No.: 14/225,412

(22) Filed: Mar. 25, 2014

Related U.S. Application Data
(60) Provisional application No. 61/924,236, filed on Jan. 7, 2014.

(51) Int. Cl. H04L 9/32; H03M 13/15; H04L 29/06; G06F 17/30; G06F 17/18

(52) U.S. Cl. CPC H04L 9/3247; G06F 17/30542; G06F 17/18; H04L 63/0876; H03M 13/151

(57) ABSTRACT

Methods and apparatuses for detecting known message codes embedded in message data that is subsequently distorted, by recognizing fragments of the message code contained in said message data, and determine statistically the likelihood that the said message codes are present. This current invention helps to recover embedded information that may otherwise be lost due to distortion. One particularly useful application is in enhanced watermark detection in audio, video and other multimedia contents.

### CROSS-REFERENCE TO RELATED APPLICATIONS

Current application claims priority from U.S. Provisional Patent Application No. 61/924,236, entitled “Methods and Apparatuses for Pattern Detection in Noisy Communication Data”, filed on Jan. 7, 2014 by current inventor. That prior provisional application is therefore on referred as The Provisional.

### FIELD OF INVENTION

The current invention relates to the field of intelligence, security, forensics, steganography and communication. One particular field is the recovery of damaged steganography or watermark messages contained in multimedia contents. Another field is in the recovery of communication data from a noisy communication channel. Yet another field is recovery of data from damaged storage media. The current invention can also be used in fuzzy pattern recognitions like face, retina or fingerprint pattern matching.

### BACKGROUND OF INVENTION

Communication is the process of delivering specific information from a sender to a receiver using a signal channel like a computer network or a wireless radio. Steganography is a special form of communication by camouflaging secret information within other information content that is being communicated to deliver said secret information to intended receiver undetected by any party not familiar with the specific methods of camouflaging. Specifically, steganography messages, called watermarks, can be embedded in multimedia contents like audio, video and images, and be retrieved.

In most forms of communication, information is sequentially applied to a signal and then the signal is delivered to a receiver to recover said information, also sequentially. Particularly, in digital forms of communication, information is partitioned into series of bits Os and 1 s before they are embedded in a signal and delivered. The receiver would try to recover such sequence of 0 s and 1 s from received signal. Hopefully the bit sequence received is identical to the one originally sent, and the information recovered is identical to the information originally sent.

However, in practice things may not work ideally. Signal can be distorted by noise or by intentional manipulation. The received bit sequence may be distorted with some bits altered and moved. In some cases such distortions render the information bits unrecognizable, and information is lost unrecoverable.

When the signal distortion is limited, some information bits are delivered intact. It may be possible to determine the altered bits based on bits correctly received, thus recover the entire information content. Researchers have developed numerous methods and apparatuses for such information recovery. Such prior arts of error correction in the field of signal communication are too many to be enumerated here.

In all prior arts of error correction methods known to the inventor of current invention, it is generally assumed that although the signal can be distorted, leading to individual bits being altered, but the time sequence of the signal itself, thus the sequence of information bits, is assumed to be left un-altered.

For one example, the sent information (ASCII code of “Gold”) is a sequence of 32 bits as following:
01000111011011110110110001100100 (ASCII code 47 6F 6C 64=“Gold”)

In receiving bit 14 and 16 is altered, with all other bits intact and occurring at correct locations:
01000111011010100110110001100100 (ASCII code 47 6A 6C 64=“Gjld”)

Since most bits are un-altered and occur at the correct locations, if we know before hand the word represents a metal, it is not difficult to guess that the correct word is “Gold” instead of “Gjld”.

Prior arts of error correction methods assume that sequences are not altered, because in most practical cases of communication the time sequence does not change. A radio wave leaves the broadcast tower in sequence and arrives at a receiver in sequence. A computer network would deliver bits in the same sequence as they were received, etc. In most process of signal copying delivery, the time sequence is simply not change, while the bits can be altered due to intentional or natural noise introduced.

However, if the sequence of signal bits is allowed to change, it is much more difficult to recognize the bits and recover the alternation. For example if first bit of the above example is moved to the last bit:
10001110110111101101100011001000 (ASCII code 8E DE D8 C8=“\check{Z}PØÈ”)

The above scrambled bit sequence is completely un-recognizable when compared with the original bit sequence, even though only one bit was moved. Every correct bit now occurs at the wrong position. There are ample prior arts of detecting and correcting bit errors occurring during communication, like Hamming code, BCH code, and LDPC (Low Density Parity Check). A web site that provides many error code correction methods can be found at the web site http://www.eccpage.com/.

However all previous error code correction methods proposed assume that time sequence is undistorted, only individual bits are. Since sequence distortion is extremely unlikely in common communication methods, and since such sequence distortion greatly increases the complexity and difficulty in error correction, there has been no prior art known to current inventor that handles error correction and information recovery with the assumption that the signal bit sequence is allowed to be altered.

However, in certain situations, signal bit sequence can be altered. One example is in steganography message delivery via media content. An innocent party, not knowing the steganography message in the media content, but in full possession of said media content, may wish to disrupt the delivery of said steganography or watermark message.

Since the party has full possession of the media content, the party can arbitrarily altering the media content, including altering the sequence of the media content. Thus, a method or apparatus that provides the capability of recognizing and recovering information pattern despite of alternation of the information bit sequence, is novel, useful, and non-obvious to some one familiar with the general arts in the practice fields. Such a method or apparatus can be used to recover steganography information, and can also be used in other fields of information recovery, including recovery of damaged network data, recovery of data from damaged data storage medium, and even recovery of DNA sequences from damaged trace materials in the field of biological analysis.

The methods can be used in any information recovery and/or forensics analysis in law enforcements. The methods can also be used in other potential applications not mentioned here.

### SUMMARY OF INVENTION

The present invention provides methods and apparatuses for recognizing patterns of information bits and possibly recovering information that would otherwise be lost by recognizing fragments of bit patterns and calculate the possibility whether such fragments occur randomly, or occur as a portion of a pattern that represent deliberately incorporated information. When the said possibilities calculated indicate that random occurrences of said bit pattern fragments are highly unlikely, the original bit pattern and its related information is declared to be present in the signal and thus recovered.

Information intentionally incorporated in a signal is generally composed of a series of bits 0s and 1s. In ideal situation, the entire series of such bits is fully recovered correctly in the correct sequence to deliver the information to its intended receiver. In practice, some bits can be altered, and more over, the sequence of bits can be altered to a certain degree, rendering the pattern of entire series of bits non-recognizable to the receiver.

An improved method is thus needed to recognize distorted information. If the alternation of bits as described above is severe, no information can be recovered, as all the bits will appear to be completely random and carries no information. However, in situations that such alternation is limited, small fractions of the complete bit pattern can still be recognized, and be used to identify and reconstruct the original information, by statistics calculation.

Given that a signal channel delivers a series of N information bits, B1, B2, . . . BN. And given that a message code pattern, composed of n bits, b1, b2, b3, . . . bn, may be present in the received bits but in distorted order. We want to determine if the information pattern is indeed present or not.

In methods provided by current invention, a fragment of r bits is selected from the first r bits in the received bit sequence. It is then determined whether the fragment of r bits occurs in the expected message code pattern or not. The determinations and the positions from which the r bits are extracted are recorded for later analysis.

We then move forward by one bit and then select another r bits for the same analysis, and repeat. Once we exhausted all bits from the received bit sequence, the frequency of occurrences of bit fragments will tell us whether such bit fragments occur randomly or not. When the matching bit fragments occur at a significantly higher occurrence rate than what can be explained as random occurrence, we declare that the expected information pattern is indeed present in the bits.

The specific details of calculating the possibilities correctly using relevant mathematical principles belong to the domain of basic science, and are not intended as included in the scope of current claims.

However, all embodiments of the methods and apparatuses of extracting bit fragments from sequence of received bits, and comparing such fragments with known bit patterns for matching, and using such results for possibility calculations to determine the likeliness that information is present, are intended to be included within the scope of current claims.

Inventor of present invention is not aware of any prior art in the field of error correction and data recovery, under the condition that signal sequence is allowed to be altered, and/or only a fragment of bits are matched for information determination. For all intent and purpose, the current invention is the first known art that provide said error correction and data recovery, under said conditions. Thus the current invention is superior to any prior art in the same fields.

### BRIEF DESCRIPTION OF DRAWINGS

FIG. 1 shows an example of input bit sequence of 256 bits. The bit sequence is originally created by repeating a 32 bits message code for 8 times, but is subsequently distorted due to either unintentional distortion from noisy communication channel, or deliberate distortion applied to conceal the message. The upper half of the figure shows the bit sequence before distortion. The lower half of the figure shows the bit sequence as a result of distortion.

FIG. 2 shows an example 32 bits message code embedded in the input bit sequence. The upper part of the figure shows the 32 bits message code. The lower part of the figure shows 25 unique bit fragments of 7 bits each. These 25 bit fragments should occur in any input bit sequence with high occurrence frequency, even if the bit sequence is distorted. Otherwise, these bit fragments should occur not much more frequent than accounted for due to coincidental random occurrences.

FIG. 3 shows the distorted input bit sequence, with dashed lines identifying bit fragments that match the 25 bit fragments in the given message code. The high occurrence of these dashed line, total 150, as well as the way they cluster into groups, strongly suggests that they are not random occurrences, but rather they are present because the given message code is embedded in the input bit sequence.

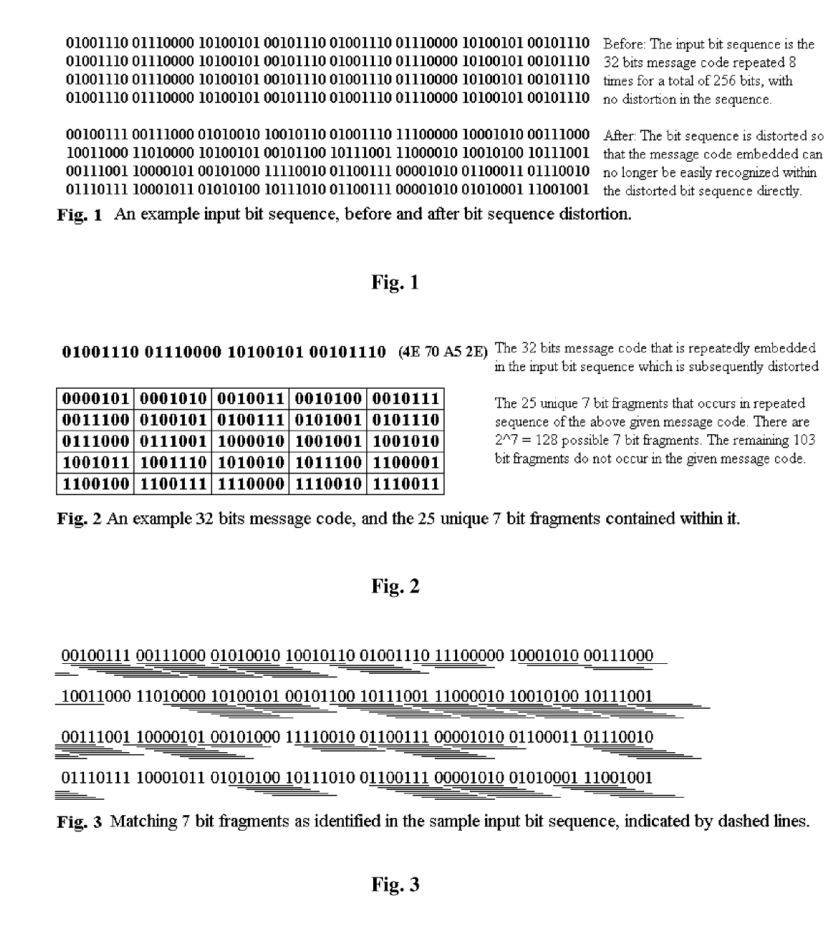

### DETAILED DESCRIPTION OF INVENTION

The current invention provides methods and apparatuses for identification of embedded information pattern in signal data that has been distorted, by recognizing fragment bit patterns in said signal data and calculating the possibility value of said bit fragments occurring randomly, and that of said bit fragments belonging to an expected information pattern. When said possibility values thus calculated indicates that it is highly unlikely that the bit fragments occur randomly, said information pattern is declared discovered and exist in the signal data.

In one embodiment of current invention, known steganography messages may be present in an audio or visual content, yet the data is so distorted that information bits recovered do not match the original steganography message in a correct sequence of bit pattern. The embodiment of methods according to current claims allows it to be determined with high confidence that the said steganography message is indeed present in the signal data, thus the said steganography message otherwise lost is recovered.

Specifically, information bits are first extracted from the audio content, based on methods used to extract said steganography messages. Such information bits, noted as B1, B2, B3, . . . BN, have been distorted and their sequence scrambled. We will apply methods in accordance to current invention to identify and recover steganography messages from said information bit sequence.

### Sample Data Used to Illustrate Example Embodiments

For an example of embodiment of Claim 1, we use a 32 bits message code 4E70A52E, as given below:
01001110 01110000 10100101 00101110 (In Hex: 4E 70 A5 2E)

The embedded steganography message is constructed by repeating the steganography code 8 times:
01001110 01110000 10100101 00101110 01001110 01110000 10100101 00101110 01001110 01110000 10100101 00101110 01001110 01110000 10100101 00101110 01001110 01110000 10100101 00101110 01001110 01110000 10100101 00101110 01001110 01110000 10100101 00101110 01001110 01110000 10100101 00101110 (4E 70 A5 2E 4E 70 A5 2E 4E 70 A5 2E 4E 70 A5 2E 4E 70 A5 2E 4E 70 A5 2E 4E 70 A5 2E 4E 70 A5 2E)

When the steganography message is received and extracted, the bits were scrambled as following:
00100111 00111000 01010010 10010110 01001110 11100000 10001010 00111000 10011000 11010000 10100101 00101100 10111001 11000010 10010100 10111001 00111001 10000101 00101000 11110010 01100111 00001010 01100011 01110010 01110111 10001011 01010100 10111010 01100111 00001010 01010001 11001001 (27 38 52 96 4E E0 8A 38 98 DO A5 2C B9 C2 94 B9 39 85 28 F2 67 0A 63 72 77 8B 54 BA 67 0A 51 C9)

Referring to Claim 1, step 1A, the above bit sequence gives an example of input bit sequence that contains the original steganography code, but with the bits distorted so that the message code cannot be directly identified in the input bit sequence.

### Determining if Original Message Code is Present or not

We want to determine if the original 32 bits message code is present in the input or not. Referring to Claim 1 step 1B, we choose a fragmentation size of 7 bits for the determination. Referring to step 1C, within the original sequence of the message code, we identify 25 possible bit fragments as following:
0000101, 0001010, 0010011, 0010100, 0010111, 0011100, 0100101, 0100111, 0101001, 0101110, 0111000, 0111001, 1000010, 1001001, 1001010, 1001011, 1001110, 1010010, 1011100, 1100001, 1100100, 1100111, 1110000, 1110010, 1110011 (5,10,19,20,23,28,37,39,41,46,56,57,66,73,74,75,78,82,86,97,100,103,112,114,115)

Referring to Claim 1 step 1D, we go through the input bit sequence received. At each bit position, we copy the next 7 bits and increment the corresponding fragment count. We also see if it matches one of the 25 bit fragments, and record the match count. Since there are 128 possible 7 bits fragments, the fragment counts can be written as a vector of 128 dimensions:
Input Vector=(0,0,1,0,1,6,0,0,1,1,7,1,0,2,2,1,1,1,1,6,12,0,3,3,3,2,1,1,8,2,1,0, 0,2,1,3,1,9,4,4,3,10,1,0,2,1,3,0,1,2,2,2,1,1,0,1,6,6,1,2,2,0,0,0, 0,1,6,1,1,2,2,3,1,5,5,5,5,0,8,0,1,3,9,2,1,1,0,0,0,2,1,0,4,1,1,0, 1,5,2,2,5,1,1,4,1,1,1,0,0,0,2,1,5,2,4,3,1,0,0,2,1,1,0,0,0,0,0,0)

For example, at No. 1 position, bit fragment 0010011 is copied. It is fragment number 19, as 0010011 is decimal number 19. First fragment is fragment 0. This is a matching fragment in the message code.

For another example, at No. 29 position, bit fragment 0110010 is copied. This is fragment 50. It is not a matching fragment as it does not occur in the message code.

For Example A, referring to Claim 1 step 1E, we identify a total of 150 matching bit fragments out of 256 positions, and calculate that 150/256=58.6% of bit fragments are matching ones. See below:
Match Vector=(0,0,0,0,0,6,0,0,0,0,7,0,0,0,0,0,0,0,0,6,12,0,0,3,0,0,0,0,8,0,0,0, 0,0,0,0,0,9,0,4,0,10,0,0,0,0,3,0,0,0,0,0,0,0,0,0,6,6,0,0,0,0,0,0, 0,0,6,0,0,0,0,0,0,7,5,5,0,0,8,0,0,0,9,0,0,0,0,0,0,0,0,0,4,0,0,0, 0,5,0,0,5,0,0,4,0,0,0,0,0,0,0,0,5,0,4,3,0,0,0,0,0,0,0,0,0,0,0,0)

Referring to Claim 1 step 1F, we note that there are 2̂7=128 possible 7 bit fragments. Only 25 of them occur in the message code. Therefore if the bits occur randomly, we expect 25/128=19.5% of matching fragments in the bit sequence. Since we identify 58.6% matching fragments, which is far higher than 19.5%, we declare that the original steganography code is discovered in the message.

Referring to Claim 2, we can further improve the possibility calculation by noting relative positions of matching bit fragments. When the relative positions of matching bit fragments seems to correlate to the same positions of said bit fragments in the message code in good agreement, it increases the possibility that such agreement is due to presence of the message code in the input bits, and not due to random coincidence. The specific calculation belongs to the domain of mathematical science, and is not intended to be included within the scope of current claims. Thus the calculation is not elaborated.

### High Confidence of Reliable Determination

In the above Example A, we expect only 19.5% matching fragments should the input be random data. But we identified 58.6% matching fragments, or 150 out of 256. Based on the high percentage we concluded that the message code was embedded in the input data. How confident are we here?

Based on knowledge of statistical mathematics, when the sample size is large, random occurrence of matching bit fragments closely obeys the Poisson Distribution formula:

P(X)=L̂X*Exp(−L)/X!

Here L is the expected number of matching bit fragments, and P(X) is the random possibility that exactly X matching bit fragments occur, X being an integer. In Example A, we expect in average a 25 matching bit fragments out of a possible 128, and there are 256 possible positions to extract a fragment. So the average expected match, L, is calculated as L=( 25/128)*256=50.

Thus the possibility that X matching bit fragments is found is calculated as:

$$P ( 0 ) = L \hat{} 0 * Exp ( - L ) / 0 != Exp ( - 50 ) = 1.9 10 \hat{} - 22$$

$$P ( 1 ) = L \hat{} 1 * Exp ( - L ) / 1 != 50 \hat{} 1 * Exp ( - 50 ) / 1 = 9.64 10 \hat{} - 21$$

$$P ( 2 ) = L \hat{} 2 * Exp ( - L ) / 2 != 50 \hat{} 2 * Exp ( - 50 ) / 2 = 2.4 10 \hat{} - 19$$

$$…$$

$$P ( 50 ) = L \hat{} 50 * Exp ( - L ) / 50 != 50 \hat{} 50 * Exp ( - 50 ) / 50 != 5.63 10 \hat{} - 2$$

$$…$$

$$P ( 150 ) = L \hat{} 150 * Exp ( - 50 ) / 150 != 50 \hat{} 150 * Exp ( - 50 ) / 150 != 2.365 10 \hat{} - 30$$

$$P ( 151 ) = L \hat{} 151 * Exp ( - 50 ) / 151 != 50 \hat{} 151 * Exp ( - 50 ) / 151 != 7.832 10 \hat{} - 31$$

$$P ( 152 ) = L \hat{} 152 * Exp ( - 50 ) / 152 != 50 \hat{} 152 * Exp ( - 50 ) / 152 != 2.576 10 \hat{} - 31$$

$$P ( 153 ) = L \hat{} 153 * Exp ( - 50 ) / 153 != 50 \hat{} 153 * Exp ( - 50 ) / 153 != 8.419 10 \hat{} - 32$$

As we can see, the possibility that the number of matching bit fragments is 50, the average expectation, is the highest, at around 5.63%. The possibility of finding much fewer or much more than 50 matching drop exponentially. There is only roughly 3×10̂−30 of chance that we find 150 or more matching by random chance. Thus the fact that we discover 150 matching bit fragments gives us extremely high confidence that it does not occur randomly, and that the steganography message was coded in the data.

### Determine the Absence of Unrelated Message Codes

Now refer to Claim 3. For Example B, there is another 32 bit message code 8FD4F811 that may be used. We want to determine if the second message code is present or absent. The second message code is:
10001111 11010100 11111000 00010001 (In HEX: 8F D4 F8 11)

We go through the same procedure as described previously to determine if the message code is present in the bit sequence or not. There are 31 unique 7 bit fragments in the message code.

Subsequently we determine that there are 45 matching bit fragments from 256 positions in the bit sequence. That's a matching ratio of 45/256=17.6%. For random bit sequence, we expect a match ratio of 31/128=24.2%. Since our match ratio of 17.6% is not significantly higher than the 24.2% random match ratio, we declare that the second steganography message code is not present in the input data.

Likewise, we can define a number of possible 32 bit steganography message codes to be used. One of the message codes will be used to embed the original steganography message. We go through the above procedures to make determination by calculating matching bit fragment counts against each of the known message codes. One of the message codes will give a particularly high matching count and is determined to be the one present in the message; all others will give a matching count not much better than a random match count, and will be determined to be absent in the message.

### A Method for Quick and Easy Determination

One easy method of determination, as an embodiment of Claim 1 step 1F, is to first calculate a 128 dimensional vector based on the input, using methods described previously. Each component of the vector represents count of how many times the corresponding fragment occurs in the input. Then we use the same method to calculate a 128 dimensional vector to represent count of fragments in message code.

Finally, we calculate the inner product of the input vector and the message code vector. To calculate the inner product, we multiply each component of first vector by the corresponding component in the second vector, and we sum up the 128 multiplication results. The message codes that give high inner product are the message codes determined to exist in the input data.

To illustrate how such calculation helps to quickly determine the presence of a given message code, we go back to Example A. Based on the input data we calculated a 128 dimensional vector as following:
Input Vector=(0,0,1,0,1,6,0,0,1,1,7,1,0,2,2,1,1,1,1,6,12,0,3,3,3,2,1,1,8,2,1,0, 0,2,1,3,1,9,4,4,3,10,1,0,2,1,3,0,1,2,2,2,1,1,0,1,6,6,1,2,2,0,0,0, 0,1,6,1,1,2,2,3,1,5,5,5,5,0,8,0,1,3,9,2,1,1,0,0,0,2,1,0,4,1,1,0, 1,5,2,2,5,1,1,4,1,1,1,0,0,0,2,1,5,2,4,3,1,0,0,2,1,1,0,0,0,0,0,0)

We then calculate a similar 128 dimensional vector from repeated sequence of message code 4E70A52E:
Message Code Vector=(0,0,0,0,0,1,0,0,0,0,1,0,0,0,0,0,0,0,0,1,2,0,0,1,0,0,0,0,2,0,0,0, 0,0,0,0,0,2,0,1,0,2,0,0,0,0,1,0,0,0,0,0,0,0,0,0,1,2,0,0,0,0,0,0, 0,0,1,0,0,0,0,0,0,1,1,1,0,0,2,0,0,0,2,0,0,0,0,0,0,0,0,0,1,0,0,0, 0,1,0,0,1,0,0,1,0,0,0,0,0,0,0,0,1,0,1,1,0,0,0,0,0,0,0,0,0,0,0,0)

To calculate the inner product, we take each of the components of the Input Vector and multiply it with the corresponding component of the Message Code Vector, and sum up the multiplication productions. The result is 212.

We repeat the same calculation for Example B, message code 8FD4F811. The inner product is only 45.

Should the input be uncorrelated random data, since there is a total 256 bit fragments scattered among 128 unique fragments, the average of each component is 256/128=2.0. Since the sum of all components in a message code is 32. Thus, for a random input data and an unrelated message code, the expectation value of the inner product will be 2.0*32=64.

As we can see, message code A gives an inner product of 212, which is significantly much higher than the random expectation value, thus it is determined to be present in the input. But message code B gives an inner product of only 45, which is not significantly higher than random expectation value 64. Thus message code B is determined to be absent from input data.

### Current Invention has Broad Usages in Many Applications

The current invention provides profound and useful ideas that large but poorly defined or badly distorted data patterns can be reliably identified by identifying and matching small fragments of it and statistically determining the likelihood that the original pattern is indeed present in the data being examined.

All the methods described in the above embodiment examples can be incorporated into an apparatus in Claim 7. The embodiment of the apparatus can be in software form or in hardware form, both of which is intended to be included within the scope of current claims. The apparatus calculates and outputs a determination of presence, based on an input bit sequence and a plural of message codes.

The message code size, size of bit fragments can vary. All variations and improvements of above embodiment examples are intended to be included within the scope of current claims declared herein. The methods and their principles can also be applied in the field of biological analysis, where a DNA sequence, partially damaged, is the input bit sequence to be analyzed, and DNA fragments are the bit fragments whose presences in the DNA sequence are to be determined, and DNA pairs are the bits.

Any and all embodiments in biological analysis and in other fields of information determination and pattern recognitions are intended to be included within the scope of current claims declared herein.

### INDUSTRIAL APPLICABILITY

The current invention is novel, useful and non-obvious and can be utilized in the industrial application of but not limited to: information technology, watermarking in audio and visual contents, copyright management, privacy protection, information communication, counter-intelligence and national security, DNA sequence determination in biology, forensic analysis of computer data and law enforcement. One particular notable usage of the current invention is in fast scanning to recognize and identify known computer viruses and malwares in a computer system. Another notable usage is in speech recognition, facial recognition, finger print recognition and other pattern recognitions. All these technology fields share one thing in common which is that they all contain information patterns that are not necessarily in logical and sequential orders, and they all may be fuzzy and distorted, and recognition by matching the entire pattern is impossible, however the patterns can be recognized in small parts, with high confidence. Thus the novel idea of current invention that we can recognize a big pattern by recognizing many small pieces is a profound and powerful idea that is useful in a broad range of fields of pattern recognitions.

1. A method of processing input bit sequence to identify a message code within, comprising:
1A. Providing that such input may contain a known message code but is also distorted;
1B. Selecting a proper number of bits which form a bit fragment;
1C. Identifying all unique bit fragments contained in a given message code;
1D. Identifying each and all bit fragments in said input bit sequence and determining if they match any bit fragment contained in the given message code;
1E. Calculating the statistics of matching and non-matching bit fragments;
1F. Determining based on possibility if said input bits contains said message code or not.

2. A method of processing input bit sequence according to claim 1, wherein distributions and relative positions of matching bit fragments are also used to calculate said probability for determining if said input bits contain said message code or not.

3. A method of processing input bit sequence according to claim 1, wherein more than one possible message codes may be embedded in the input bit sequence, and calculation is repeated for each of the message codes for determination whether they are contained in said input bits or not.

4. A method of processing input bit sequence according to claim 1, wherein said input bit sequence is obtained from hidden watermark information embedded in audio or visual content using any watermark embedding and detection technology, and message codes are the expected watermark pattern whose presence is to be detected using said method.

5. A method of processing according to claim 1, wherein the input sequence is a damaged DNA sequence for biological analysis, and message codes are DNA fragments whose presence in the said DNA sequence is to be determined, and each bit is a DNA pair.

6. A method of processing according to claim 1, wherein the input sequence represents phonetic units detected in a recorded speech data, and message codes are possible words or phrases, bit fragments represent the basic unit of speech, and the problem is to recognize spoken words in the speech data.

7. An apparatus of embodiment using the method according to claim 1.

8. An apparatus of embodiment using the method according to claim 4.

9. An apparatus of embodiment using the method according to claim 5.

10. An apparatus of embodiment using the method according to claim 6.
